(19) United States
(12) Patent Application Publication
(10) Pub. No.: US 2025/0172380 A1
(43) Pub. Date: May 29, 2025

(54) PARALLEL PLATE MEASUREMENT APPARATUS FOR BATTERY THICKNESS MEASUREMENT

(71) Applicant: Microsoft Technology Licensing, LLC, Redmond, WA (US)

(72) Inventors: Benjamin Edward NEWTON, Van Buren Township, MI (US); Gregory Scott YODER, Snoqualmie, WA (US); Jeffrey D. BRUCE, Kirkland, WA (US); Douglas A. MARTIN, Woodinville, WA (US)

(21) Appl. No.: 18/519,634

(22) Filed: Nov. 27, 2023

(51) Int. Cl. G01B 11/06; G01D 5/347; G01K 7/02; H02J 7/00

(52) U.S. Cl. CPC G01B 11/06; G01D 5/34753; G01K 7/02; H02J 7/0069

(57) ABSTRACT

A parallel plate measurement apparatus for measuring battery thickness includes a stationary bottom plate and a dynamic top plate fixed in a parallel orientation relative to the stationary bottom plate. The dynamic top plate is adapted to slide linearly along a first rail bearing in a direction perpendicular to the stationary bottom plate, and the system further includes a counterweight adapted to slide linearly along a second rail bearing in the direction perpendicular to the stationary bottom plate. Additionally, the parallel plate measurement apparatus further includes a pivot arm with a first end flexibly coupled to the dynamic top plate and a second end flexibly coupled to a counterweight. The pivot arm is adapted to rotate about a pivot bearing to apply directionally-opposing forces to the counterweight and dynamic top plate that, in turn, impart movement on the counterweight and the dynamic top plate that is constrained by the first rail bearing and the second rail bearing. The system still further includes a linear encoder adapted to measure a separation between the stationary bottom plate and the dynamic top plate.

### BACKGROUND

In small-sized tablets and laptops, battery size is a significant factor that that constrains the minimum device size. In these and other portable electronics, it is not unusual for the device battery to take up a third or more of the available volume inside of the device casing. When a device manufacturer purchases a battery from a battery supplier, is critical that the battery be manufactured according to precise specifications to ensure proper fit within a battery compartment designed to receive the battery. One consideration when selection batteries and designing battery compartments is the fact that batteries swell and “thicken” throughout their lifetimes due to a gradual build of natural gases such as carbon dioxide. Battery thickness can also vary with temperature and throughout each individual charge cycle. For example, batteries tend to be thickest when the stored charge is greatest (e.g., near 100%) and thinnest when the stored charge is lowest (e.g., near 0%).

Understanding how battery size is likely to change over time is critical to predicting whether a given type of battery is a good candidate for a given device in terms of device longevity and also for understanding if and when an aging battery is likely to impact a device's performance. If a battery within a device swells to the point of contacting and applying an outward pressure to the walls of the device's battery compartment, this outward pressure has the potential to impact the functionality of nearby electronics. If, for example, display circuitry or touchpad haptics are in close proximity to the battery compartment, an output pressure originating within the battery compartment could cause undesirable effects such as display flickering or touchpad malfunction (e.g., failing to register a user's tap or touch).

### SUMMARY

According to one implementation, a parallel plate measurement system includes a stationary bottom plate and a dynamic top plate fixed in a parallel orientation relative to the stationary bottom plate. The dynamic top plate is adapted to slide linearly along a first rail bearing in a direction perpendicular to the stationary bottom plate. The parallel plate measurement system further includes a counterweight adapted to slide linearly along a second rail bearing in the direction perpendicular to the stationary bottom plate, and a pivot arm with a first end flexibly coupled to the dynamic top plate and a second end flexibly coupled to a counterweight. The pivot arm is adapted to rotate about a pivot bearing to apply directionally-opposing forces to the counterweight and dynamic top plate. The directionally-opposing forces impart movement on the counterweight and the dynamic top plate that is constrained by the first rail bearing and the second rail bearing. The parallel plate measurement system further includes a measurement tool adapted to measure a separation between the stationary bottom plate and the dynamic top plate.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates a parallel plate measurement system designed to sample battery thickness measurements during dynamic battery cycling within a thermal chamber.

FIG. 2 illustrates views demonstrating directionally-opposing movements of a counterweight and a dynamic top plate within an example parallel plate measurement system.

FIG. 3 illustrates additional features of an example parallel plate measurement system.

FIG. 4 illustrates additional features of an example parallel plate measurement system.

FIG. 5 illustrates additional views of an example parallel plate measurement system for measuring thickness of a battery.

FIG. 6 illustrates example operation for using a parallel plate measurement apparatus to measure thickness of a battery while the battery is being charge cycled within a temperature-controlled thermal chamber.

FIG. 7 illustrates an example schematic of a processing device suitable for implementing aspects of the disclosed technology,

### DETAILED DESCRIPTION

Understanding when a battery is likely to swell to the point of interfering with device performance could advantageously provide manufacturers with the ability to render meaningful battery maintenance recommendations and/or implement preemptive measures to safe hardware components to prevent irreparable component damage related to battery swelling. Currently available tools for measuring battery thickness are offer low-resolution and low-fidelity measurements that cannot be easily correlated with battery characteristics (e.g., cycle count, charge location, temperature) to facilitate generation of meaningful predictive metrics.

Battery thickness tests are routinely performed in a thermal chamber that is maintained at a temperature that simulates the thermal environment of an electronic device. While in the thermal chamber, the battery is cycled fully—e.g., charged to a maximum and depleted to a minimum-repeatedly over a number of days. Per these existing testing operations, the battery is removed from the thermal chamber every few cycles and manually repositioned within parallel plate measurement tool that is then used to measure a thickness of the battery. This physical removal of the battery from the thermal chamber is motivated by the fact that existing parallel plate measurement tools exhibit poor thermal tolerance due to the fact that these tools typically rely on springs or crystals to gauge thickness, both of which are subject to thermal expansion and contraction that skews resulting measurements, making them unreliable for measurements within the thermal chamber itself. In addition, the thermal chamber is tightly constrained in z-direction height, and existing thickness measurement tools inherently possess a z-direction form factor that exceeds this size constraint. For the above-described reasons, existing parallel plate measurement tools are kept and used at ambient conditions (external to the thermal chamber) and the battery is removed from the thermal chamber to perform each measurement.

The above-described physical removal of the battery from the thermal chamber to perform the thickness measurement reduces measurement accuracy due to cooling of the battery that causes thermal contraction during a “relocation interval” while the battery is being moved and set up for the thickness measurement. Additionally, when a warm or hot battery comes into contact with a cool (e.g., ambient temperature) measurement device, this can cause a source/sink effect that further draws heat away from the battery, causing still further thermal contraction. Notably, the length of this relocation interval is variable from one reading to the next due to variations in human behavior, such as how long it takes a given technician to remove the battery and measure it. Consequently, this existing measurement methodology undesirably permits variable cooling as well as variable charging/discharging in the time period immediately preceding each measurement. This variability, in turn, makes it impractical to reliably correlate battery thickness measurements with battery characteristics such as charge cycle location and temperature.

Another problem with existing measurement tooling and battery thickness measurement methodology arises as a result of the force that the measurement device applies to the battery. Typically, battery thickness is measured by sandwiching a battery between two parallel plates and measuring the plate-to-plate separation. In this set-up, the top plate is typically free-floating and thus applies its entire weight as a downward force on the battery during the measurement. This downward force has the potential to compress the battery which is, in many cases, a flexible pouch (e.g., like a pillow). Compressing the battery alters the battery thickness which, in turn, skews the measurement.

The herein disclosed technology includes a parallel plate battery measurement apparatus and measurement methodology that addresses all of the foregoing problems. The parallel plate battery measurement apparatus has a high thermal tolerance, small form factor, and exceptionally high resolution (e.g., on the order of a few microns), which allow it to fit within the z-direction constrained thermal chamber and collect highly-reliable, high-resolution battery thickness measurements while the battery is being cycled. In one implementation, the z-direction height of the thermal chamber is 70 m and the z-direction height of the disclosed parallel plate battery measurement apparatus is 68 mm. Thus, the battery does not need to be removed from the thermal chamber for each thickness measurement. This capability of collecting measurements in a thermally-controlled environment while the battery is being cycled (as opposed to pausing the cycling and displacing the battery from the thermal environment) saves operator time and makes it feasible to sample battery thickness at a high frequency throughout each of multiple (e.g., thousands) of battery charge cycles. This, in turn, provides high fidelity data (e.g., sampled at high frequency, such as every once per second), from which it is possible to fully understand how battery thickness correlates with charge cycle, battery age, and temperature. This high frequency sampling capability significantly improves the trend analysis capability and, consequently, the accuracy of battery thickness predictions that are based on observed trends during this testing as compared to previous measurement tools and methodologies that supported measurement once every few days or weeks (e.g., 1 sample every 15 days).

According to one implementation, the disclosed technology includes a measurement apparatus that leverages a linear encoder to perform battery thickness measurements. The linear encoder is programmed to count a number of optically-readable markings on an encoder strip that pass through a detection region when the separation between parallel plates is altered. The use of the linear encoder with the particular herein-disclosed characteristics contributes to the small form factor, thermal tolerance, and high resolution of the herein disclosed measurement apparatus.

In addition to the above, the disclosed measurement apparatus also includes an adjustable counterweight that facilitates a “tuning” of the downward force that a top plate imparts on the battery during measurement. Notably, use of a very light downward force facilitates a more accurate measurement of the battery's unconstrained thickness. As mentioned above, previous measurement systems were inherently limited in the accuracy of this unconstrained measurement due to gravitational force of the free-floating upper plate that flattens the battery. There exist some scenarios in which it is helpful to know both (1) when (e.g., in terms of charge cycle count, charge level, and temperature) a battery will swell to the point of contacting battery compartment walls; and (2) when continued battery swelling will create an outward pressure on the compartment walls and therefore potentially damage the device. In general, the first scenario can be simulated by measuring battery swelling while the battery is under minimum compression. In contrast, the second scenario mentioned above can be simulated by observing by measuring battery swelling while the battery is under very high compression—e.g., when the battery is at or near its maximum volumetric energy density.

In view of the above considerations, there exists a need for a parallel plate measurement apparatus that applies a highly tunable downward force to the object being measured-specifically, a force that can be reduced to near zero and increased to a very large value. The herein disclosed measurement apparatus uniquely facilitates this bi-directional force tunability via an architectural design that also provides the small z-direction form factor that is needed for the measurement apparatus to fit within thermal chambers commonly used to conduct battery cycle testing. To simulate unconstrained battery swelling to a predefined critical thickness (e.g., the point at which the battery swells to contact battery compartment walls), the herein disclosed measurement apparatus can be tuned to apply a very light, near-zero downward force on the battery while sampling thickness over many battery cycles. In contrast, to simulate battery swelling up to (and/or beyond) the predefined critical thickness while the battery is compressed to its maximum volumetric energy density, the herein disclosed measurement apparatus can be tuned to apply a very heavy, compressive force to the battery while sampling the battery over multiple battery cycles.

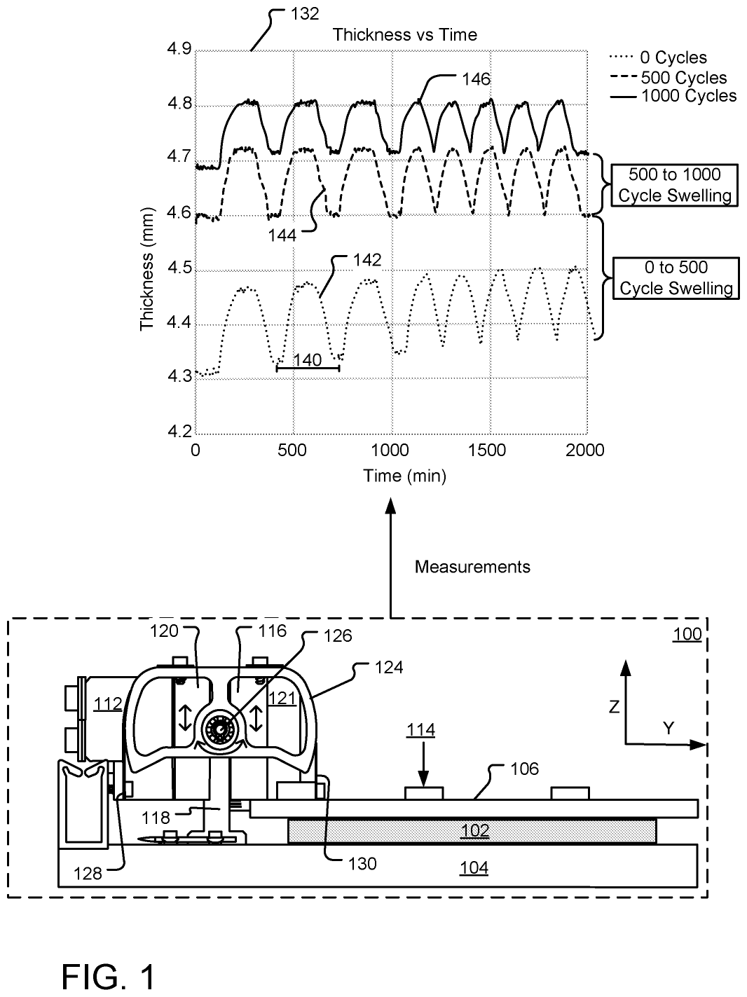

FIG. 1 illustrates a parallel plate measurement system 100 designed to sample battery thickness measurements during dynamic battery cycling within a thermal chamber. The parallel plate measurement system 100 includes a stationary bottom plate 104 and a dynamic top plate 106 adapted to move in a direction perpendicular to the stationary bottom plate 104 (e.g., the z-direction illustrated). In the side profile of FIG. 1, a battery 102 is shown sandwiched between the dynamic top plate 106 and the stationary bottom plate 104. This illustrates proper positioning of the battery 102 to sample a battery thickness measurement with the parallel plate measurement system 100. In this configuration, the relative separation between the dynamic top plate 106 and the stationary bottom plate 104 corresponds to the z-direction battery thickness, which is typically the thinnest dimension of the battery 102.

In various implementations, the parallel plate measurement system 100 is sized to measure batteries with different characteristics. However, it at least one implementation, the parallel plate measurement system 100 provides a z-direction thickness measurement with a resolution that is on the order of a few (e.g., 1-10 microns).

The stationary bottom plate 104 is designed to rest flush against a supportive parallel surface, and the dynamic top plate 106 is fixed in a parallel orientation relative to the stationary bottom plate 104. The dynamic top plate 106 is “dynamic” in the sense that it is designed to rest against the battery 102 as shown and move up and down, in the z-direction, in response to swelling and contraction of the battery 102. The dynamic top plate 106 is also referred to herein as “free-floating” because it designed to apply at least some of its weight as a downward force 114 on the top of the battery 102. When the battery 102 is removed form the illustrated position, a gravitational force acting on the dynamic top plate 106 causes the dynamic top plate 106 to slide down and contact the stationary bottom plate 104.

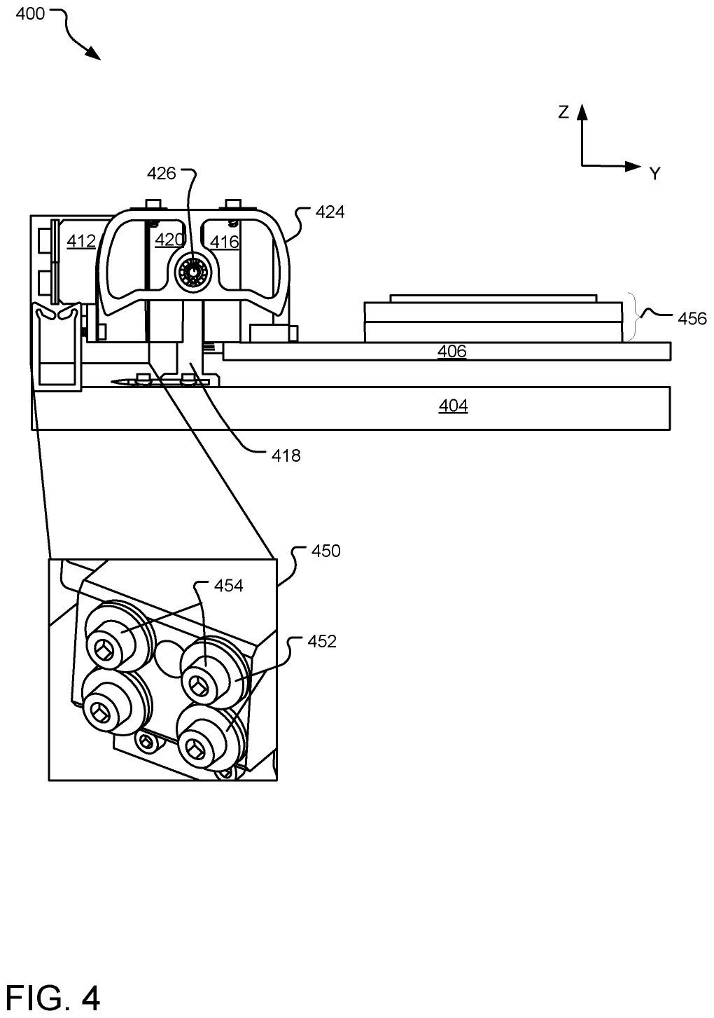

The downward force 114 that the dynamic top plate 106 applies to the battery 102 is tunable in magnitude to due the inclusion of a counterweight 112, which has an adjustable mass (discussed in more detail with respect to FIG. 4). Although some implementations of the parallel plate measurement system 100 may support the capability to tune the mass of the counterweight 112 to a mass equal or greater than the mass of the dynamic top plate 106, battery thickness measurements are more accurate when the downward force 114 is set to a non-zero value such that there is at least some downward force applied.

The parallel plate measurement system 100 includes a stabilizing mast portion 118 that extends away from the stationary bottom plate 104 in a direction perpendicular or substantially perpendicular to the stationary bottom plate 104 (e.g., the z-direction). Opposite sides of the stabilizing mast portion 118 serve as anchor points for connection mechanisms that slidably couple the dynamic top plate 106 and the counterweight 112 to the stabilizing mast portion. In one implementation, the connection mechanisms include a pair of rail bearings 116 and 120 that function to provide parallel, z-direction movement axes for the dynamic top plate 106 and the counterweight 112. In the implementation of FIG. 1, each of the rail bearings 116 and 120 includes a high precision linear rail slidably coupled to a bearing. The linear rails are coupled to opposite sides of the stabilizing mast portion 118. A first bearing slidably coupled to the linear rail of rail bearing 116 protrudes (e.g., in the negative y-direction) from a vertical support member 121 that is fixedly attached to the dynamic top plate 106. When the bearing slides along the rail, the vertical support member 121 and the dynamic top plate 106 move up and down (as a single unit) in the z-direction. Likewise, a second bearing coupled to the linear rail of the rail bearing 120 protrudes (e.g., in the positive y-direction) from the counterweight 112, thereby providing the counterweight 112 with a movement axis that is parallel to that of the dynamic top plate 106.

In one implementation, the parallel plate measurement system 100 is calibrated to ensure that both the counterweight 112 and the dynamic top plate 106 are constrained to move in exclusively the direction that is perpendicular to the stationary bottom plate 104 (e.g., the z-direction). For example, alignment operations for pitch, roll and yaw are performed in the initial build of parallel plate measurement system 100 employed to ensure that movement axes of the rail bearings 116 and 120 are tuned to be parallel to one another with a high degree of precision (e.g., to within +/−0.1 mm parallel plate offset) and also perpendicular to the stationary bottom plate 104 and the dynamic top plate 106.

Notably, the rail bearings 116 and 120 are not physically coupled to one another. Kinetic force transfer between the dynamic top plate 106 and the counterweight 112 is not achieved by the rail bearings 116 and 120 but is, instead, achieved by way of a pivoting mechanism 122 coupled to flexible bands 128 and 130 that apply directionally-opposing (e.g., up/down) forces on the counterweight 112 and the dynamic top plate 106, respectively. The pivoting mechanism that includes a pivot arm 124 with center of mass rotatably coupled to a pivot bearing 126. The pivot bearing 126 is mounted to the stabilizing mast portion 118 and supports bidirectional rotation of the pivot arm 124. The pivot bearing 126 acts like the fulcrum of a lever, with the counterweight 112 on one side serving to apply a downward (z-direction) gravitational force turns the pivot arm 124 in a first direction about the pivot bearing 126, which—in turn—serves to apply a lift force to the dynamic top plate 106. Likewise, movement of the pivot arm 124 is the opposite direction (e.g., due to gravitational force of the dynamic top plate 106) applies a lift force to the counterweight 112, with the lift/lower balance being determined by the respective mass of the dynamic top plate 106 and the counterweight 112.

The pivot arm 124 has a first end flexibly coupled to the counterweight 112 by the flexible band 128 and a second end flexibly coupled to the dynamic top plate 106 by the flexible band 130. The flexible bands 128 and 130 are designed to flex (e.g., torque) in response to rotation of the pivot arm 124 and thereby prevent the rotation of the pivot arm 124 (e.g., clockwise and counterclockwise in the y/z plane as shown) from imparting a corresponding rotation on the dynamic top plate 106 and the counterweight 112 around the pivot bearing 126. In various implementations, the flexible bands comprise a variety of different materials with different characteristics. However, the flexible bands 128 and 130 are—in general—flexible enough to torque and absorb y-direction rotational force components of the pivot arm 124 but also rigid enough to resist collapse (e.g., folding back on itself) when subjected to normal-use positive z-direction forces. For example, when a user lifts the dynamic top plate 106, the flexible band 130 maintains some rigidity that prevents the dynamic top plate 206 from contacting the pivot arm 224. In one implementation, the flexible bands comprise thin metal strips (e.g., less than 0.1 mm thick), such as stainless steel (e.g., type 301 stainless steel) or other material.

Due to the flex properties of the flexible bands 128 and 130, the dynamic top plate 106 and the counterweight 112 stay completely fixed in their respective x and y orientations while transferring only z-direction force back-and-forth through the pivot arm 124. If, in contrast, the flexible bands 128 and 130 were replaced with rigid components, rotation of the pivot arm 224 would impart a corresponding rotation on the dynamic top plate 106 and the counterweight 112 about the pivot bearing 226. This, in turn, would distort the parallel alignment of the two plates and potentially skew the resulting thickness measurement. Due to the “flex” capability of the flexible bands 128 and 130 in the presently disclosed design, the y-direction component of rotation about the pivot bearing 126 is entirely absorbed in the form of torsion acting on the flexible bands 128 and 130. It is exclusively the z-component of the rotation about the pivot bearing 226 that contributes to positional changes of the dynamic top plate 106 and the counterweight 112 to create a pull/push effect effective to lift and lower of the dynamic top plate 106 and the counterweight 112 (in opposing directions) along the rail bearings 116 and 120, respectively.

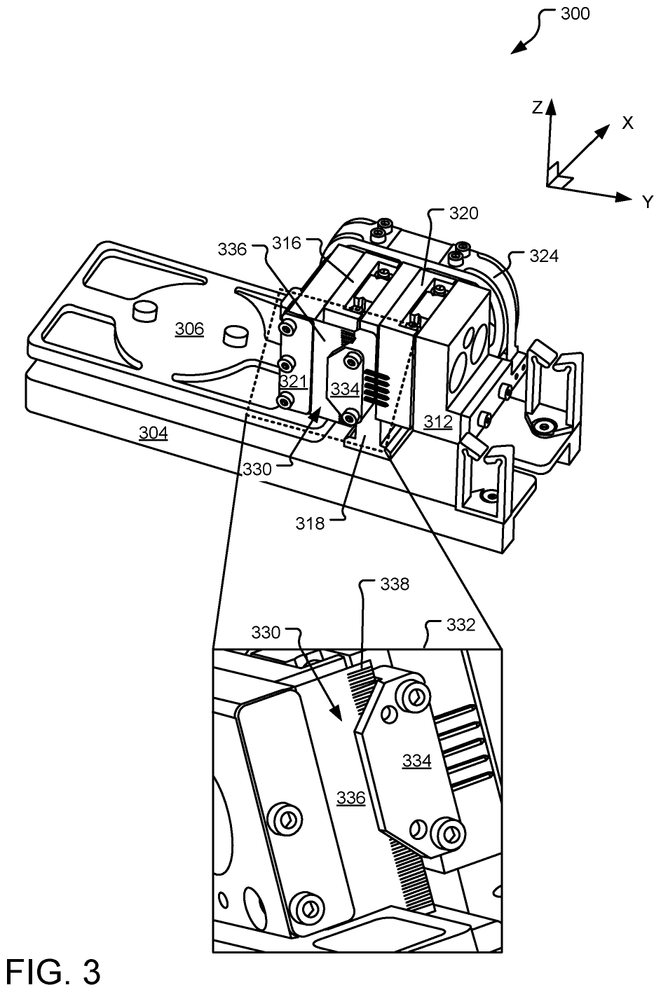

The parallel plate measurement system 100 includes a thermally tolerant, high resolution measurement tool (not shown in FIG. 1) that measures the separation between the dynamic top plate 106 and the stationary bottom plate 104. Additional example details of this tool are discussed with respect to FIG. 3.

In one implementation, the battery 102 remains positioned between the stationary bottom plate 104 and the dynamic top plate 106 (as shown) while being charge cycled—e.g., from at or near 0% charge to at or near 100% charge-many times repeatedly, while positioned within a thermal chamber that provides a temperature-controlled environment.

An example plot 132 illustrates data collected by the parallel plate measurement system 100 the during a single experiment spanning multiple days or weeks. During the experiment, the parallel plate measurement system 100 is placed within a thermal chamber and the battery 102 is positioned as shown, with circuitry attached to both the battery 102 and the measurement tool (not shown) on the parallel plate measurement system 100. The circuitry is configured to repeatedly charge and discharge the battery all while collecting and recording temporally coinciding samples of battery charge, cycle count, battery thickness, and temperature. To create the plot 132, the sampling frequency was set to once every second for a time period spanning a number of weeks.

In the plot 132, the x-axis represents time elapsed during the experiment while the y-axis illustrates changes in battery thickness while the battery 102 is cycled more than 1000 times. During each individual cycle, the battery 102 is thickest in z-direction thickness when it is charged to its maximum and thinnest when it has discharged to a minimum. Thus, from the illustrated time/thickness dataset, it is possible to see the duration of each charge cycle (e.g., a single charge cycle spanning sub interval 140) and to count the total number of charge cycles throughout the experiment. To more easily provide visual comparison of small thickness changes that occur over long time intervals, the plot 132 includes three lines corresponding to data taken during the experiment during three different non-consecutive time intervals that each span an interval length of 2000 minutes.

Specifically, a first line 142 illustrates battery thickness data collected during 2000 minutes that occur early in the experiment—e.g., somewhere within the first 0 and 500 cycles of the battery 102. Notably, only 8 full battery cycles are completed over the illustrated 2000-minute interval, and it is assumed that the battery cycling continues for several more cycles before the start of a time interval that corresponds to a second line 144.

The second line 144 illustrates battery thickness data collected during another 2000-minute interval that occurs sometime between the 500^{th} and 1000^{th} cycle for the battery 102. Since the battery 102 has aged considerably in the elapsed experiment time (not shown) between the datasets corresponding to the first line 142 and the second line 144, maximum and minimum thickness during each of the cycles shown on the second line 144 exceeds the maximum battery thickness observed during the time interval corresponding to the first line 142.

Although the second line 144 again illustrates just eight cycles in 2000 minutes, it is assumed that the battery cycling continues for many more cycles before the start of a time interval corresponding to a third line 146. The third line 146 illustrates battery thickness data collected during another 2000-minute interval following the 1000th battery cycle. Here, the maximum and minimum thickness during each cycle exceeds the maximum thickness observed the time interval represented by the second line 144.

Although not shown in FIG. 1, some implementations of the parallel plate measurement system 100 include thermocouples for monitoring temperature of the battery 102 and also the ambient air in the thermal chamber, allowing temperature data to be further correlated with the data shown in the plot 132.

Given a known “critical thickness” of interest (e.g., a z-direction of a battery compartment in a given device), it is possible to use the plot 132 to determine when, in terms of time and battery characteristics such as cycle count, charge level, and temperature (if available), the battery reaches the critical thickness. In one implementation, the illustrated experiment is performed with a select (e.g., heavy) weight applied to the dynamic top plate 106 that compresses the battery 102 to a sufficiently high or maximum volumetric energy density. Here, the “critical thickness” of the battery 102 also correspond to the point in time at which the battery 102 will begin applying an outward (potentially damaging) force on the walls of the battery compartment.

Given the high fidelity data captured in the plot 132 that precisely correlates cycle count and charge level with high-frequency samples of battery thickness, it becomes possible to reliably utilize battery characteristics such as charge cycle count, location within charge cycle, and temperature (if sampled, although not shown in FIG. 1), to predict when other instances of the battery 102 (e.g., with identical characteristics) will-when in use in the field-swell to the critical thickness. This prediction, in turn, can be used to provide an end user with timely and meaningful battery maintenance (e.g., replace/repair) recommendations and, in some cases, to implement software control safeguards designed to protect nearby hardware, such as controls that forcibly disable certain hardware components.

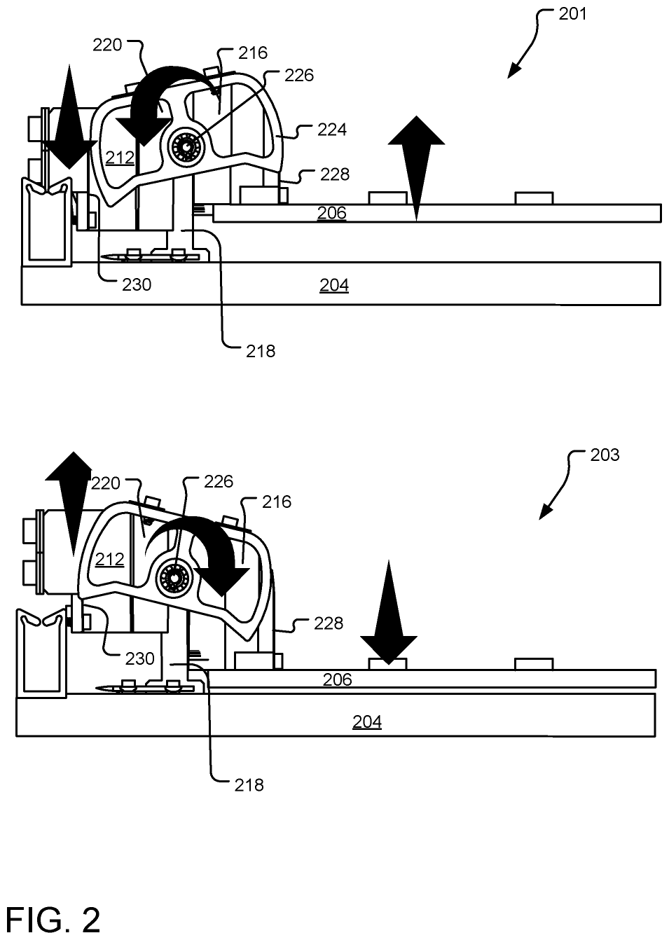

FIG. 2 illustrates two views 201, 203 demonstrating directionally-opposing movements of a counterweight 212 and a dynamic top plate 206 within an example parallel plate measurement system 200. In one implementation, the parallel plate measurement system 200 includes physical characteristics the same or similar to those described above with respect to FIG. 1 including a stationary bottom plate 204, a stabilizing mast portion 218 that protrudes vertically from the stationary bottom plate 204 and serves as an anchor point for linear rail bearings 216 and 220 which support linear (z-direction) movement of the dynamic top plate 206 and the counterweight 212, respectively. The counterweight 212 has an adjustment mass.

A pivot arm 224 has a center of mass rotatably mounted to a pivot bearing 226 affixed to the stabilizing mast portion 218. A first end of the pivot arm 224 is attached to the dynamic top plate 206 by a first flexible band 228 and a second opposite end of the pivot arm 224 is attached to the counterweight 212 by a second flexible band 230. Functional aspects of the parallel plate measurement system 200 not specifically described with respect to FIG. 2 are assumed to be the same or similar to like-named components described elsewhere herein.

The view 201 illustrates movement of the parallel plate measurement system 200 that occurs when an upward force is applied to the dynamic top plate 206. For example, a user gently lifts the dynamic top plate 206 to allow for insertion of a battery between the dynamic top plate 206 and the stationary bottom plate 204. This lift force causes the dynamic top plate 206 to slide upward (in the positive z-direction) along the linear rail bearing 216 and the upward movement of the dynamic top plate 206 applies an upward “push” force on the flexible band 228 which, in turn, rotates pivot arm 224 in a counterclockwise direction (as shown).

Since the counterweight 212 and the dynamic top plate 206 are physically constrained in the x and y directions, the y-direction component of the illustrated rotation causes the flexion of the flexible bands 228 and 230 but does not affect corresponding y-directionals movements of either the dynamic top plate 206 or the counterweight 212. Rather, the illustrated counterclockwise rotation of the pivot arm about the pivot bearing 226 transfers a z-direction component of the rotational force through the flexible band 230, pushing downward on the counterweight 212. This force causes the counterweight 212 to slide down (e.g., in the negative z-direction) along the linear rail bearing 220 in by a distance equal and opposite to the upward movement of the dynamic top plate 206.

The view 203 illustrates an opposing movement of the parallel plate measurement system 200 that occurs in response to a downward (negative z-direction) force applied to the dynamic top plate 206. For example, the user releases their hand from the dynamic top plate 206 and (provided that the mass of the dynamic top plate 206 exceeds the mass of the counterweight 212) the dynamic top plate 206 falls downward under gravitational force (as shown), contacting with the stationary bottom plate 204.

The illustrated downward force causes the dynamic top plate 206 to slide downward (in the negative z-direction) along the linear rail bearing 216 and also pulls downward on the flexible band 228 which, in turn, rotates pivot arm 224 in a clockwise direction (as shown). In this case, the illustrated clockwise rotation of the pivot arm 224 about the pivot bearing 226 creates a vertical (upward) pull on the flexible band 230, pulling upward on the counterweight 212. In response, the counterweight 212 to slides upward (e.g., in the positive z-direction) along the linear rail bearing 220 in by a distance equal and opposite to the downward movement of the dynamic top plate 206.

FIG. 3 illustrates additional features of an example parallel plate measurement system 300. The view of FIG. 3 provides visibility of an opposite side of the parallel plate measurement system 300 that is hidden in the views shown in FIGS. 1 and 2. Components common to both of the parallel plate measurement system 300 and the systems of FIGS. 1 and 2 include dynamic top plate 306, a stationary bottom plate 304, a counterweight 312 with an adjustable mass, linear rail bearings 316 and 310, a stabilizing mast portion 318, and a pivot arm 324 that rotates about a pivot bearing (not shown) to impart the forces described above with respect to FIG. 2. Other features and functional characteristics not specifically described with respect to FIG. 3 are assumed the same or similar to like-named components in FIG. 1 or 2.

In addition to the above components, the view of FIG. 3 illustrates aspects of a measurement tool 330 that is mounted to the stabilizing mast portion 318 on a side that is opposite that supporting the pivot bearing and pivot arm 324. A magnified view 332 illustrates the measurement tool 330 in greater detail. The measurement tool 330 includes a linear encoder 334 and an encoder strip 336. In the illustrated implementation, the linear encoder 334 is mounted to the stabilizing mast portion and the encoder strip 336 is mounted to a vertical support member 321 that extends from (and that is mounted to) the dynamic top plate 306. The dynamic top plate 306, vertical support member 328, and encoder strip 336 move in the z-direction as a single unit. Therefore, movement of the dynamic top plate 306 along the linear rail bearing 316 causes the encoder strip 336 to move through a detection region. The linear encoder 334 uses a sensor to detect z-direction positional changes of the encoder strip 336 and a transfer function is applied to translate positional changes of the encoder strip 336 to a battery thickness measurement (e.g., relative separation between the dynamic top plate 306 and the stationary bottom plate 304).

In the illustrated implementation, the linear encoder 334 is a transmissive optical encoder module that includes a light source and a detector. The encoder strip 336 is made of a transparent or semi-transparent material and includes a number of finely pitched optically-readable lines 338 (e.g., etched grooves or opaque markings). Although other characteristics may be suitable, the encoder strip 336 is, in one implementation, a transparent or semi-transparent mylar linear strip with a thickness of .007 inches that does not expand or contract when subjected to temperatures in the range of −40 degrees Celsius up to 100 degrees Celsius.

The linear encoder 334 shines the light source (e.g., a lensed LED source) onto the encoder strip 336 and measures light received at a detector (e.g., a monolithic detector IC) positioned on the other side of the encoder strip 336. Specifically, the detector is programmed to count the fine-pitched evenly spaced lines on the encoder strip as they pass through a detection region. In one implementation where the linear encoder 334 has the above-noted characteristics, the parallel plate measurement system 300 can take battery thickness measurements with 4 micron resolution. The linear encoder 334 has a form factor and has a z-direction height that is, in one implementation, less than 1.5 inches. The entire z-direction height of the parallel plate measurement system 300 is, in one implementation, about 70 mm.

In another implementation, the position of the linear encoder 334 and the encoder strip 336 is interchanged such that the linear encoder 334 moves with the dynamic top plate 306 while the encoder strip 336 remains fixed, resulting in a measurable shift in the relative positions of the encoder strip 336 and the linear encoder 334.

In some implementations, the measurement tool 330 includes a linear magnetic encoder that uses magnetic sensing to measure positional changes.

FIG. 4 illustrates additional features of an example parallel plate measurement system 400 with features the same or similar to those discussed with elsewhere herein including a dynamic top plate 406, a stationary bottom plate 404, a counterweight 412 with an adjustable mass, linear rail bearings 416 and 420, a stabilizing mast portion 418, and a pivot arm 424 that rotates about a pivot bearing 426 to impart imposing push/pull forces on the dynamic top plate 406 and the counterweight 412, respectively.

In addition to the above, FIG. 4 includes a magnified view 450 that illustrates example features of the counterweight 412. The counterweight 412 is adjustable in mass and includes a number of protruding supports 454 onto which an operator can manually add or remove weighted washers 452, thereby altering mass of the counterweight 412. Likewise, the dynamic top plate 406 is shown to be positioned below stacked weights 456 that can be added or removed as an additional way of selectively tuning the mass that applies the downward force to the battery during measurement.

As described elsewhere herein, there exist motivations, from a device design perspective, to be able to measure changes in unconstrained battery thickness as well as changes in the battery thickness that are observed while the battery is compressed to at or near its maximum volumetric energy density. These different types of measurements can be facilitated by adjusting mass of the counterweight 412 and/or the mass applied directly to the dynamic top plate (e.g., the stacked weights 456).

One systematic problem stemming from current battery measurement methodologies is the lack of measurement standardization across batteries with different size characteristics. In existing measurement systems, common practice is to tune the downward force acting on the battery during measurement to a preselected target value. However, if two different batteries with different cross-sectional profiles (e.g., length multiplied by width) are subjected to this preselected target downward force during measurement, the batteries are actually subjected to different pressures due to the fact that pressure is equal to force divided by the cross-sectional contact area. Due to this difference in pressure, the two batteries subjected to the same downward force may be compressed by different amounts. This measurement methodology providing for application of a constant downward force during measurement of batteries with different cross-sectional profiles serves as a potential source of systematic error that makes it difficult, if not impossible, for device manufacturers to compare battery thickness specifications provided for batteries with different cross-sectional profiles.

To address the foregoing and provide device manufacturers with standardized battery thickness specifications, one herein-disclosed method of using the parallel plate measurement system 400 provides for standardizing a degree of downward pressure rather than the magnitude of downward force that is applied to each different battery during measurement. For a given type of thickness measurement (e.g., unconstrained battery thickness versus battery thickness at maximum volumetric energy density), the parallel plate measurement system 400 is selectively tuned—by the operator—to apply a preselected target downward pressure on the battery through the dynamic top plate 406. For a measurement of unconstrained battery thickness, this predefined target pressure is selected to be a very small (e.g., positive but near-zero) value (e.g., 0.01 pressure per square inch (PSI)). Likewise, for a measurement of battery thickness at at or near the maximum volumetric energy density, this predefined target pressure is selected to be very large (e.g., 100 PSI).

When preparing to conduct an experiment that samples battery thickness measurements during active battery cycling, an operator determines the amount of mass to add or remove to the opposing sides of the parallel plate measurement system 400 by multiplying the preselected target pressure by the cross-sectional area (e.g., length multiplied by width) of the battery being measured. This yields the corresponding desired downward force that can then be divided by the gravitational constant to yield a corresponding target effective mass of the dynamic top plate 406. In instances where the effective target mass is less than a moving mass on the right-hand side of the illustrated system (e.g., the mass of the portion that moves up and down as a single unit), the operator can then add weight to the counterweight 412 (on the left-hand side) to effectively “remove” a corresponding amount of the moving mass from the right-hand side. Likewise, in instances where the effective target mass is more than the moving mass on the right-hand side of the illustrated system, the operator can elect to increase the effective weight of the dynamic top plate 406 by removing mass from the counterweight 412 and/or add by adding mass directly to the top of the dynamic top plate (e.g., by adding one or more of the stacked weights 546) moving mass (e.g., by stacking additional weight directly on top of the dynamic top plate 406) to adjust the moving mass to equal the target effective mass.

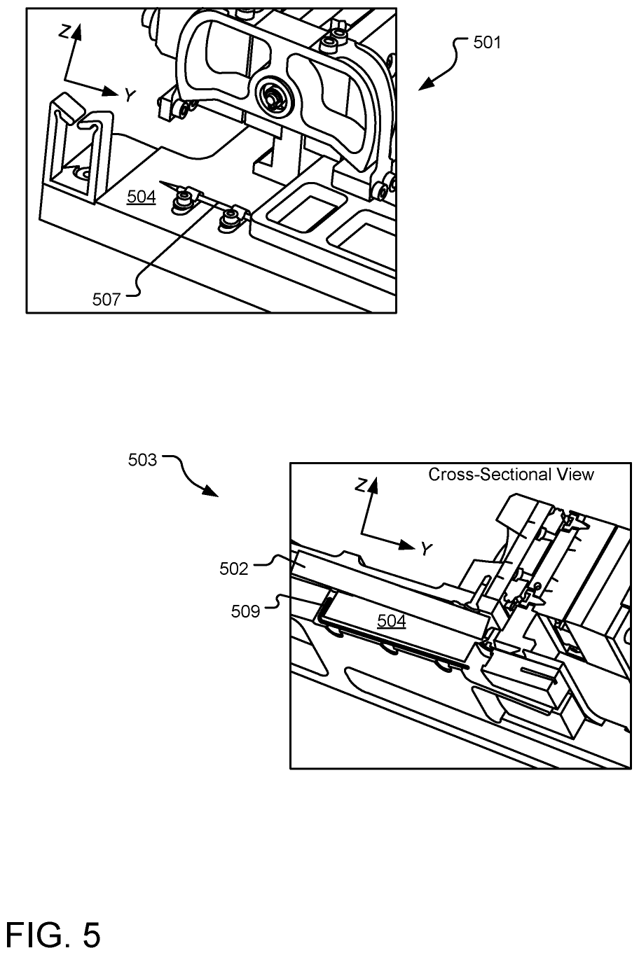

FIG. 5 illustrates additional views 501 and 503 of an example parallel plate measurement system 500 for measuring thickness of a battery 502 as described elsewhere herein. Axes labeling of FIG. 5 is consistent with the axes labeling in FIGS. 3 and 4. The parallel plate measurement system 500 includes features the same or similar as those described with respect to any of FIG. 1-4 but additionally includes thermocouples 507, 509 adapted to sample temperatures during battery cycling that coincide with battery thickness measurements taken with the parallel plate measurement system 500.

Changes in battery thickness correlate with changes in battery temperature and it is therefore critical to thermals related to battery. In a given device, a battery may have a wide range of typical operating temperatures (ex: 0 C-45 C). These operating temperatures are a product of the ambient environment combined with heat that the battery produces when charging and discharging (e.g., adding Δ0 C-Δ10 C to the ambient temperature at any given point in time). Understanding how battery temperature changes throughout the charge cycle and how these changes influence changes in battery thickness can enable more accurate in-field predictions of changes in battery thickness, particularly in devices with temperature sensors that can detect ambient environment conditions from which it is usable to predict current battery temperature (e.g., given a known charge level of the battery).

In the implementation shown in FIG. 5, a first thermocouple 507 is visible in perspective view 501 while a second thermocouple 509 is visible in cross-sectional view 503. Both of the thermocouples 507 and 509 are K-type thermocouples with electrical termination via connector housings mounted to a bottom side of the parallel plate measurement system 500. The thermocouple 507 shown in the perspective view 501 serves as an ambient environment temperature sensor that measures temperature changes of ambient air within a thermal chamber or other environment in which the parallel plate measurement system 500 is located. In one implementation, an experimental setup includes many different instances of the parallel plate measurement system 500 on several shelves inside a thermal chamber, and a thermal uniformity matrix is collected to monitor any deviation from a setpoint-thereby providing a measurement of ambient temperature that is more accurate than the setpoint for each of multiple batteries being tested concurrently within the thermal chamber.

The thermocouple 509 shown in the cross-sectional view 509 measures surface temperature of the battery 502 and is routed through the bottom plate 504 with a measurement head just below the battery 502. Temperature measurements from the thermocouple 509 are used for monitoring actual cell temperature deviation from chamber air temperature during each test.

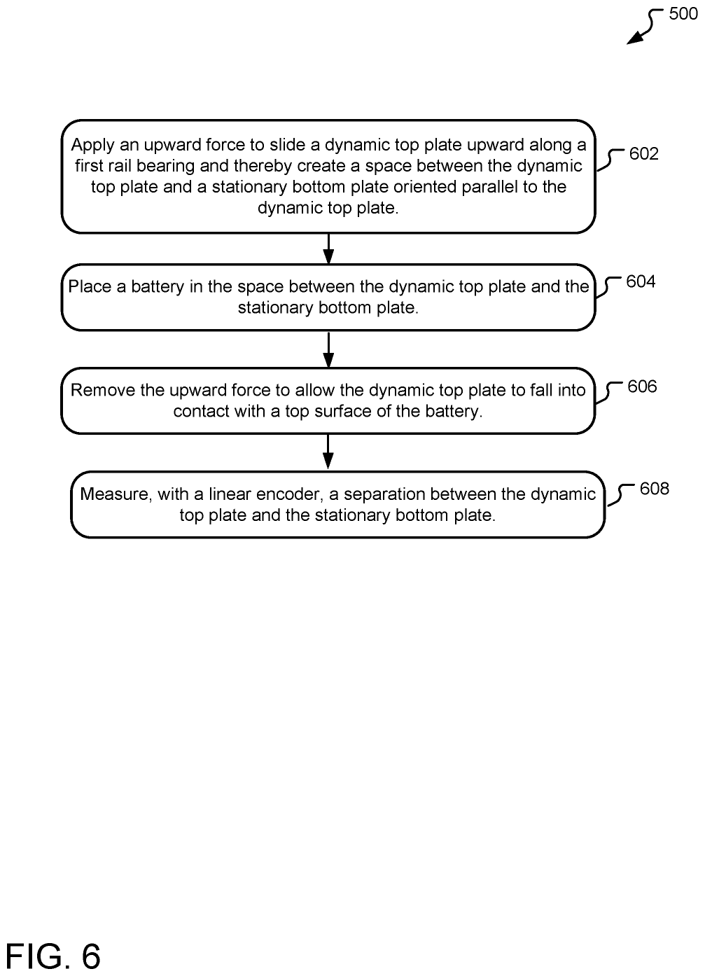

FIG. 6 illustrates example operations 600 for using a parallel plate measurement apparatus to measure thickness of a battery while the battery is being charge cycled within a temperature-controlled thermal chamber. It is assumed that the operations 600 are performed after the parallel plate apparatus is fully assembled, calibrated for precise parallel plate alignment, and placed within the thermal chamber. A force application operation 602 applies an upward force to slide a dynamic top plate of the measurement apparatus along a first rail bearing, thereby creating a space between the dynamic top plate and a stationary bottom plate orientated parallel to the dynamic top plate. The dynamic top plate is coupled to a first end of a pivot arm, and the pivot arm rotates in a first direction about a pivot bearing to lift the first end of the pivot arm upward while simultaneously lowering a second opposite end of the pivot arm attached to a counterweight. The counterweight is slidably coupled to a second rail bearing with a movement axis parallel to that of the first rail bearing.

A placement operation 604 places a battery in the space between the dynamic top plate and the stationary bottom plate, and a force removal operation removes the upward force to allow the dynamic top plate to fall into contact with a top surface of the battery. A measuring operation 608 measures, with a linear encoder, a separation between the dynamic stop plate and the stationary bottom plate.

In one implementation, the linear encoder is programmed to optically read markings on an encoder strip that passes through a detection region of the parallel plate measurement apparatus as the dynamic top plate moves up and down. If, for example, the battery swells or contracts while placed in the position described with respect to the measuring operation 608, the swelling or contraction is translated to a z-direction movement of the dynamic top plate and this movement effects a shift in relative position between a detector of the linear encoder and the encoder strip. The detector is programmed to read the number of markings on the encoder strip that pass through the detection region and a transfer function is applied to translate this positional shift to a thickness of the battery.

According to one implementation, the operations 600 further comprise repeatedly cycling charge level of the battery while the battery remains positioned between the dynamic top plate and the stationary bottom plate. During the charge cycling, a battery parameter measurement module measures certain battery characteristics. For example, the battery parameter measurement module is stored control circuitry external to the battery (e.g., specially purposed for the experiment) that part of the battery. For example, the battery includes control circuitry for monitoring battery characteristics such as a charge level, temperature, number of total lifetime charge cycles, current charge rate, current discharge rate, etc., and transmit some or all of those characteristics to an external processor, either automatically or in response to an external request for such information. During charge cycling, battery charge cycle count information is actively tracked, such as by a counter that counts the battery cycles or by capture of time/charge profile information that can be analyzed to extract a charge cycle count.

The parallel plate measurement apparatus additionally includes or is coupled to control circuitry including a sample collection module that collects charge level samples for the battery while the battery is being charge cycled, such as by measuring the battery charge directly or communicating with the battery parameter measurement circuitry. Additionally, the sample collection module communicates with a microprocessor of the measurement tool to collect a series of battery thickness measurements that temporally coincide with the charge level samples. The control circuitry stores a dataset that includes each of the charge level samples temporally correlated with a thickness measurement sampled at a corresponding measurement time. In some implementations, this dataset further includes a total charge cycle count value (e.g., cycles completed between commencement of the experiment and sampling of the thickness measurement) that temporally corresponds to each of stored thickness measurements.

In still another implementation, the operations 600 include adjusting mass of the counterweight to alter a downward force applied by the dynamic top plate to match a target downward force. In at least one implementation, the target force is selected to ensure that the dynamic top plate applies a target pressure to the battery. For example, the pressure is selected to be standardized for battery thickness measurements conducted on batteries with different cross-sectional profiles (e.g., length multiplied by width). regardless of the type and size of battery being measured. This provides standardization of thickness measurements that allows for direct comparison of batteries that have different size and charge characteristics.

In some implementations of use, the above-described dataset is used to program an electronic device to predict when (e.g., in terms of time and/or measurable battery characteristics) its battery is likely to reach a predefined critical thickness. For example, the predefined critical thickness defines a depth of a battery compartment corresponding to the z-direction thickness of the battery. With this predictive capability, the device is further programmed to take a remedial action in anticipation of damage that may occur to the device if and when the battery indeed reaches the predefined critical thickness. For example, the remedial action is triggered when characteristics of a battery of an in-field device satisfy predefined criteria defined based on the dataset (e.g., when the battery characteristics match those of the test battery associated with the critical thickness). If, for example, the battery swells to the critical thickness and contacts the walls of the battery compartment, there exists a likelihood that continued swelling of the battery beyond this point may damage the device, such as by warping the battery compartment walls and applying pressure to other fragile nearby electronic components. To prevent this, the programmed logic of the device provides for executing the remedial action when observed characteristics of the device's battery satisfy a profile correlated with the critical thickness that is derived from the dataset.

In one implementation, the remedial action is a battery maintenance recommendation. For example, the device presents a notification on a display that instructs a user to replace or service the battery. In another implementation, the remedial action includes transmitting a control signal to safe a hardware component at a select time before the before the damage is expected to occur, such as by cutting power to the component. For example, the electronic device transmits control signals to power down or otherwise protect certain hardware components in the vicinity of the battery compartment.

To illustrate an example of the above, assume that the dataset is for a test battery with identical charge characteristics to a battery that is within a given in-field electronic device being used by an end user. In one implementation where the dataset indicates that the test battery reached the predefined critical thickness when charged to a maximum on charge cycle number 1801, the in-field electronic device is programmed to recommend battery replacement after 1750 charge cycles or some other presented number preceding 1801.

In some implementations, the remedial action is executed conditionally by the device in response to determining that multiple observed characteristics of the battery satisfy a profile correlated, in the dataset, with the critical thickness. For example, the device is programmed based on instances of the test replicated in different thermal environments and the recommendations are based on observed temperatures of the device in additional to charge cycle count. If, for example, the dataset indicates that the test battery reached the critical thickness between 1800 and 1900 charge cycles when the test was performed in a test environment much hotter than an observed temperature profile of the in-field device but never reached the critical thickness when the test was conducted in a thermal environment consistent with the observed temperature profile of the in-field device, then the programmed logic may provide for not performing the remedial action when the battery reaches the 1800-1900 charge cycle count.

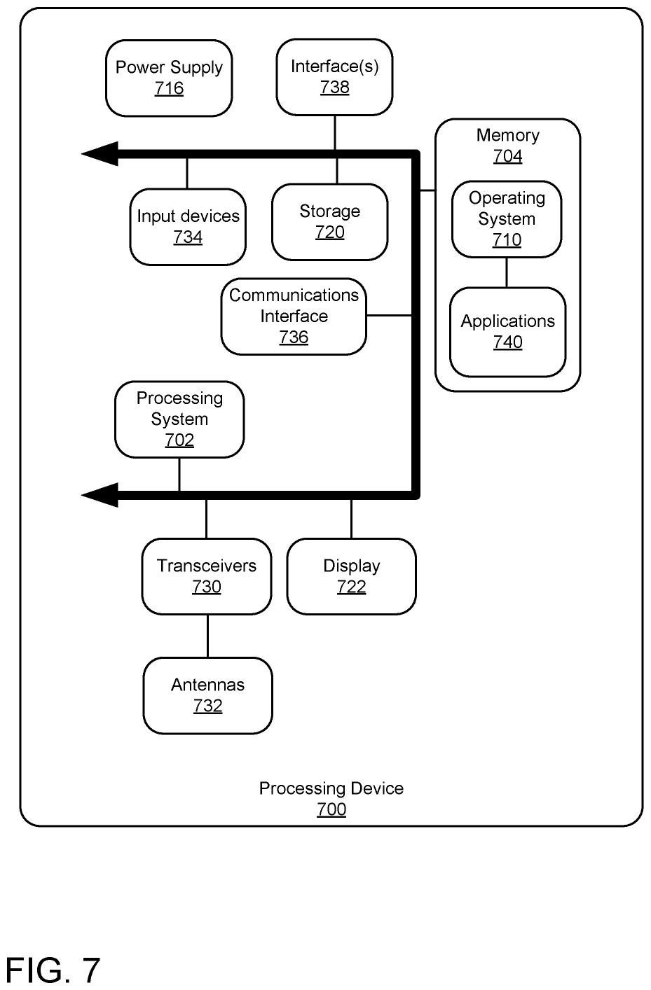

FIG. 7 illustrates an example schematic of a processing device 700 suitable for implementing aspects of the disclosed technology. The processing device 700 includes a processing system 702, memory 704, a display 722, and various input and/or output interfaces 738 (e.g., buttons). The processor unit(s) 702 may each include one or more central processing units (CPUs), graphics processing units (GPUs), etc. The memory 704 generally includes both volatile memory (e.g., random access memory (RAM)) and non-volatile memory (e.g., flash memory). An operating system 710, such as the Microsoft Windows® operating system or other operating system resides in the memory 704 and is executed by the processing system 702.

One or more applications 740 (e.g., the sample collection module and the battery parameter measurement module discussed with respect to FIG. 5) are loaded in the memory 704 and executed on the operating system 710 by the processing system 702. The applications 740 may receive inputs from one another as well as from various input local devices 734 such as a microphone, input accessory (e.g., keypad, mouse, stylus, touchpad, gamepad, racing wheel, joystick), and a camera.

Additionally, the applications 740 may receive input from one or more remote devices, such as remotely located servers or smart devices, by communicating with such devices over a wired or wireless network using more communication transceivers 730 and an antenna 732 to provide network connectivity (e.g., a mobile phone network, Wi-Fi®, Bluetooth®). The processing device 700 also includes storage (e.g., non-volatile storage) for battery charge profile data, logic for executing remedial actions based on the battery charge profile data, and more.

The processing device 700 further includes a power supply 717, which is powered by one or more batteries or other power sources, and which provides power to other components of the processing device 700. The power supply 716 may also be connected to an external power source (not shown) that overrides or recharges the built-in batteries or other power sources. Additionally, the processing device 700 includes a communications interface 736 for communicating with other processing devices across a network, such as a local area network (LAN) and/or a wide area network (WAN) (e.g., the internet).

The processing device 700 may include a variety of tangible computer-readable storage media and intangible computer-readable communication signals. Tangible computer-readable storage can be embodied by any available media that can be accessed by the processing device 700 and includes both volatile and nonvolatile storage media, removable and non-removable storage media. Tangible computer-readable storage media excludes intangible and transitory communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing device 700. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

Some implementations may comprise an article of manufacture. An article of manufacture may comprise a tangible storage medium (a memory device) to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

In some aspects, the techniques described herein relate to a parallel plate measurement system including: a stationary bottom plate; a dynamic top plate fixed in a parallel orientation relative to the stationary bottom plate, the dynamic top plate adapted to slide linearly along a first rail bearing in a direction perpendicular to the stationary bottom plate; a counterweight adapted to slide linearly along a second rail bearing in the direction perpendicular to the stationary bottom plate; and a pivot arm with a first end flexibly coupled to the dynamic top plate and a second end flexibly coupled to a counterweight. The pivot arm is adapted to rotate about a pivot bearing to apply directionally-opposing forces to the counterweight and dynamic top plate, and the directionally-opposing forces impart movement on the counterweight and the dynamic top plate that is constrained by the first rail bearing and the second rail bearing. The parallel plate measurement system further includes a measurement tool adapted to measure a separation between the stationary bottom plate and the dynamic top plate.

In some aspects, the techniques described herein relate to a parallel plate measurement system, wherein the measurement tool further includes: an encoder strip that includes optically-readable markings; a linear encoder configured to count the optically-readable markings that pass through a detection region, wherein movement of the dynamic top plate in the direction perpendicular to the stationary bottom plate causes the encoder strip to move relative to the linear encoder.

In some aspects, the techniques described herein relate to a parallel plate measurement system, wherein the counterweight has a mass adjustable to alter a downward force applied by the dynamic top plate to a battery sandwiched between the stationary bottom plate and the dynamic top plate.

In some aspects, the techniques described herein relate to a parallel plate measurement system, wherein movement of the counterweight and the dynamic top plate is constrained to the direction perpendicular to the stationary bottom plate.

In some aspects, the techniques described herein relate to a parallel plate measurement system, wherein the dynamic top plate is coupled to the first end of the pivot arm by a first flexible band and the counterweight is coupled to the second end of the pivot arm by a second flexible band, the first flexible band and the second flexible band functioning to prevent rotation of the pivot arm from imparting a corresponding rotation on the dynamic top plate and the counterweight.

In some aspects, the techniques described herein relate to a parallel plate measurement system, further including: a sample collection module stored in memory and executable to configured to: repeatedly cycle charge level of a battery while the battery is positioned between the dynamic top plate and the stationary bottom plate; while cycling the charge level of the battery, track a number of charge cycles completed while concurrently collecting a series of charge level samples and battery thickness measurements that temporally coincide with the charge level samples; and store a dataset that includes each of the charge level samples temporally correlated with a corresponding thickness measurement and the number of charge cycles completed at a corresponding measurement time.

In some aspects, the techniques described herein relate to a parallel plate measurement system, wherein the parallel plate measurement system further includes: thermocouples configured to sample a temperature of the battery and of an ambient environment during battery cycling, and wherein the sample collection module is further executable to collect samples of battery temperature and ambient air temperature that temporally coincide with the charge level samples.

In some aspects, the techniques described herein relate to a method for dynamically measuring battery thickness during cycling of a battery, the method including: applying an upward force to a dynamic top plate that slides linearly along a first rail bearing in response to the upward force to create a space between the dynamic top plate and a stationary bottom plate oriented parallel to the dynamic top plate. The dynamic top plate is coupled to a first end of a pivot arm that rotates in a first direction about a pivot bearing to lift the first end upward while simultaneously lowering a second opposite end of the pivot arm attached to a counterweight. The counterweight is slidably coupled to a second rail bearing oriented such that the counterweight slides linearly in response to the upward force in a direction opposing linear movement of dynamic top plate along the first rail bearing. The method further includes placing a battery in the space between the dynamic top plate and the stationary bottom plate; removing the upward force to allow the dynamic top plate to fall into contact with a top surface of the battery; and measuring, with a linear encoder, a separation between the dynamic top plate and the stationary bottom plate.

In some aspects, the techniques described herein relate to a method, wherein the dynamic top plate is coupled to the first end of the pivot arm by a first flexible coupling and the counterweight is coupled to a second end of the pivot arm by a second flexible coupling, the first flexible coupling and the second flexible coupling permitting the pivot arm to rotate about the pivot bearing without imparting a corresponding rotation to the dynamic top plate and the counterweight.

In some aspects, the techniques described herein relate to a method, wherein the counterweight and the dynamic top plate are adapted for movement that is exclusively in a linear direction parallel to an axis of first rail bearing and the second rail bearing.

In some aspects, the techniques described herein relate to a method, further including: wherein the linear encoder is programmed to optically read marking on an encoder strip that passes through a detection region as the dynamic top plate moves up and down.

In some aspects, the techniques described herein relate to a method, further including: repeatedly cycling charge level of the battery while the battery is positioned between the dynamic top plate and the stationary bottom plate; during the charge cycling: actively tracking a number of charge cycles completed; collecting a series of charge level samples; collecting a series of temperature measurements of the battery and ambient environment; and collecting a series of thickness measurements that temporally coincide with the charge level samples and the temperature measurements; storing a dataset that includes each of the charge level samples temporally correlated with a corresponding thickness measurement and the number of charge cycles completed at a corresponding measurement time; and programming an electronic device to generate a battery maintenance recommendation based on the dataset and one or more observed battery characteristics of a battery within the electronic device.

In some aspects, the techniques described herein relate to a method, further including: identifying a critical thickness of the battery corresponding to a predetermined likelihood of negatively impacting performance of electronic device as a result of outward pressure that the battery applies to a battery chamber, wherein the battery maintenance recommendation is a recommendation to replace the battery before the battery reaches the critical thickness.

In some aspects, the techniques described herein relate to the method of claim, further including: determining, based on a cross-sectional area of the battery, magnitude of a downward force necessary to subject the battery to a predefined target pressure; and adjusting mass of the counterweight to alter a downward force applied by the dynamic top plate to match the downward force.

In some aspects, the techniques described herein relate to a parallel plate measurement apparatus including: a bottom plate; a stabilizing mast portion secured to and protruding from the bottom plate; and a top plate affixed to a first side of the stabilizing mast portion by a first connection mechanism that locks the top plate in an orientation substantially parallel to the bottom plate while permitting selective movement of the top plate in a direction perpendicular to the bottom plate. The parallel plate measurement apparatus additionally includes a counterweight affixed to a second side of the stabilizing mast portion by a second connection mechanism that permits selective movement of the counterweight in the direction perpendicular to the bottom plate, and a pivot arm that rotates about a pivot bearing coupled to the stabilizing mast portion. The pivot arm is configured to lift the counterweight and lower the top plate when rotated in a first direction and also to lift the top plate and lower the counterweight when rotated in a second direction opposite the first direction. The parallel plate measurement apparatus additionally includes a measurement tool adapted to measure a separation between the bottom plate and the top plate.

In some aspects, the techniques described herein relate to a parallel plate measurement apparatus, wherein the measurement tool further includes: an encoder strip that includes optically-readable markings; a linear encoder configured to count the optically-readable markings that pass through a detection region, wherein movement of the top plate in the direction perpendicular to the bottom plate causes the encoder strip to move relative to the linear encoder.

In some aspects, the techniques described herein relate to a parallel plate measurement apparatus, wherein the top plate is dynamic and the counterweight is adjustable to adjust a force that the top plate applies to a battery sandwiched between the bottom plate and the top plate.

In some aspects, the techniques described herein relate to a parallel plate measurement apparatus, wherein a first end of the pivot arm is attached to top plate by a first flexible band, wherein flexing motion of the first flexible band allows the pivot arm to rotate about the pivot bearing without imparting a corresponding rotation to the top plate.

In some aspects, the techniques described herein relate to a parallel plate measurement apparatus, further including: a battery parameter measurement module stored in memory and configured to measure charge level of a battery positioned between the bottom plate and the top plate; and a sample collection module stored in memory and executable to configured to: instruct the battery parameter measurement module to collect a series of charge level samples while the battery is cycled multiple times; transmit control signals that cause the measurement tool to collect a series of thickness measurements that temporally coincide with the charge level samples; and store a dataset that includes each of the charge level samples temporally correlated with a corresponding thickness measurement and charge cycle count for the battery.

In some aspects, the techniques described herein relate to a parallel plate measurement apparatus, wherein the parallel plate measurement apparatus further includes: thermocouples configured to sample a temperature of the battery and of an ambient environment during battery cycling, wherein the dataset stored by the sample collection module includes temperature samples for the battery and the ambient environment.

The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of exemplary implementations.

What is claimed is:

1. A parallel plate measurement system comprising:
a stationary bottom plate;
a dynamic top plate fixed in a parallel orientation relative to the stationary bottom plate, the dynamic top plate adapted to slide linearly along a first rail bearing in a direction perpendicular to the stationary bottom plate;
a counterweight adapted to slide linearly along a second rail bearing in the direction perpendicular to the stationary bottom plate;
a pivot arm with a first end flexibly coupled to the dynamic top plate and a second end flexibly coupled to a counterweight, the pivot arm being adapted to rotate about a pivot bearing to apply directionally-opposing forces to the counterweight and dynamic top plate, the directionally-opposing forces imparting movement on the counterweight and the dynamic top plate that is constrained by the first rail bearing and the second rail bearing; and
a measurement tool adapted to measure a separation between the stationary bottom plate and the dynamic top plate.

2. The parallel plate measurement system of claim 1, wherein the measurement tool further comprises:
an encoder strip that includes optically-readable markings;
a linear encoder configured to count the optically-readable markings that pass through a detection region, wherein movement of the dynamic top plate in the direction perpendicular to the stationary bottom plate causes the encoder strip to move relative to the linear encoder.

3. The parallel plate measurement system of claim 1, wherein the counterweight has a mass adjustable to alter a downward force applied by the dynamic top plate to a battery sandwiched between the stationary bottom plate and the dynamic top plate.

4. The parallel plate measurement system of claim 1, wherein movement of the counterweight and the dynamic top plate is constrained to the direction perpendicular to the stationary bottom plate.

5. The parallel plate measurement system of claim 1, wherein the dynamic top plate is coupled to the first end of the pivot arm by a first flexible band and the counterweight is coupled to the second end of the pivot arm by a second flexible band, the first flexible band and the second flexible band functioning to prevent rotation of the pivot arm from imparting a corresponding rotation on the dynamic top plate and the counterweight.

6. The parallel plate measurement system of claim 1, further comprising:
a sample collection module stored in memory and executable to configured to:
repeatedly cycle charge level of a battery while the battery is positioned between the dynamic top plate and the stationary bottom plate;
while cycling the charge level of the battery, track a number of charge cycles completed while concurrently collecting a series of charge level samples and battery thickness measurements that temporally coincide with the charge level samples; and
store a dataset that includes each of the charge level samples temporally correlated with a corresponding thickness measurement and the number of charge cycles completed at a corresponding measurement time.

7. The parallel plate measurement system of claim 6, wherein the parallel plate measurement system further includes:
thermocouples configured to sample a temperature of the battery and of an ambient environment during battery cycling, and wherein the sample collection module is further executable to collect samples of battery temperature and ambient air temperature that temporally coincide with the charge level samples.

8. A method for dynamically measuring battery thickness during cycling of a battery, the method comprising:
applying an upward force to a dynamic top plate that slides linearly along a first rail bearing in response to the upward force to create a space between the dynamic top plate and a stationary bottom plate oriented parallel to the dynamic top plate;
the dynamic top plate being coupled to a first end of a pivot arm that rotates in a first direction about a pivot bearing to lift the first end upward while simultaneously lowering a second opposite end of the pivot arm attached to a counterweight, the counterweight being slidably coupled to a second rail bearing oriented such that the counterweight slides linearly in response to the upward force in a direction opposing linear movement of dynamic top plate along the first rail bearing;
placing a battery in the space between the dynamic top plate and the stationary bottom plate;
removing the upward force to allow the dynamic top plate to fall into contact with a top surface of the battery; and
measuring, with a linear encoder, a separation between the dynamic top plate and the stationary bottom plate.

9. The method of claim 8, wherein the dynamic top plate is coupled to the first end of the pivot arm by a first flexible coupling and the counterweight is coupled to a second end of the pivot arm by a second flexible coupling, the first flexible coupling and the second flexible coupling permitting the pivot arm to rotate about the pivot bearing without imparting a corresponding rotation to the dynamic top plate and the counterweight.

10. The method of claim 8, wherein the counterweight and the dynamic top plate are adapted for movement that is exclusively in a linear direction parallel to an axis of first rail bearing and the second rail bearing.

11. The method of claim 8, further comprising: wherein the linear encoder is programmed to optically read marking on an encoder strip that passes through a detection region as the dynamic top plate moves up and down.

12. The method of claim 8, further comprising:
repeatedly cycling charge level of the battery while the battery is positioned between the dynamic top plate and the stationary bottom plate;
during the charge cycling:
actively tracking a number of charge cycles completed;
collecting a series of charge level samples;
collecting a series of temperature measurements of the battery and ambient environment; and
collecting a series of thickness measurements that temporally coincide with the charge level samples and the temperature measurements;
storing a dataset that includes each of the charge level samples temporally correlated with a corresponding thickness measurement and the number of charge cycles completed at a corresponding measurement time; and
programming an electronic device to generate a battery maintenance recommendation based on the dataset and one or more observed battery characteristics of a battery within the electronic device.

13. The method of claim 12, further comprising:
identifying a critical thickness of the battery corresponding to a predetermined likelihood of negatively impacting performance of electronic device as a result of outward pressure that the battery applies to a battery chamber, wherein the battery maintenance recommendation is a recommendation to replace the battery before the battery reaches the critical thickness.

14. The method of claim, further comprising:
determining, based on a cross-sectional area of the battery, magnitude of a downward force necessary to subject the battery to a predefined target pressure; and
adjusting mass of the counterweight to alter a downward force applied by the dynamic top plate to match the downward force.

15. A parallel plate measurement apparatus comprising:
a bottom plate;
a stabilizing mast portion secured to and protruding from the bottom plate;
a top plate affixed to a first side of the stabilizing mast portion by a first connection mechanism that locks the top plate in an orientation substantially parallel to the bottom plate while permitting selective movement of the top plate in a direction perpendicular to the bottom plate;
a counterweight affixed to a second side of the stabilizing mast portion by a second connection mechanism that permits selective movement of the counterweight in the direction perpendicular to the bottom plate;
a pivot arm that rotates about a pivot bearing coupled to the stabilizing mast portion, the pivot arm configured to:
lift the counterweight and lower the top plate when rotated in a first direction; and
lift the top plate and lower the counterweight when rotated in a second direction opposite the first direction;
a measurement tool adapted to measure a separation between the bottom plate and the top plate.

16. The parallel plate measurement apparatus of claim 14, wherein the measurement tool further comprises:
an encoder strip that includes optically-readable markings;
a linear encoder configured to count the optically-readable markings that pass through a detection region, wherein movement of the top plate in the direction perpendicular to the bottom plate causes the encoder strip to move relative to the linear encoder.

17. The parallel plate measurement apparatus of claim 14, wherein the top plate is dynamic and the counterweight is adjustable to adjust a force that the top plate applies to a battery sandwiched between the bottom plate and the top plate.

18. The parallel plate measurement apparatus of claim 14, wherein a first end of the pivot arm is attached to top plate by a first flexible band, wherein flexing motion of the first flexible band allows the pivot arm to rotate about the pivot bearing without imparting a corresponding rotation to the top plate.

19. The parallel plate measurement apparatus of claim 14, further comprising:
a battery parameter measurement module stored in memory and configured to measure charge level of a battery positioned between the bottom plate and the top plate; and
a sample collection module stored in memory and executable to configured to:
instruct the battery parameter measurement module to collect a series of charge level samples while the battery is cycled multiple times;
transmit control signals that cause the measurement tool to collect a series of thickness measurements that temporally coincide with the charge level samples; and
store a dataset that includes each of the charge level samples temporally correlated with a corresponding thickness measurement and charge cycle count for the battery.

20. The parallel plate measurement apparatus of claim 18, wherein the parallel plate measurement apparatus further comprises:
thermocouples configured to sample a temperature of the battery and of an ambient environment during battery cycling, wherein the dataset stored by the sample collection module includes temperature samples for the battery and the ambient environment.
